(19) United States
(12) Patent Application Publication
(10) Pub. No.: US 2011/0169862 A1
(43) Pub. Date: Jul. 14, 2011

(54) METHOD AND SYSTEM FOR DISPLAYING DIGITAL MEDICAL IMAGES

(75) Inventors: Ganesha DARBHE PADMANABHA, Erlangen (DE); Sandra HADER, Furth (DE); Mohammed RAHIMUDDIN, Erlangen (DE); Andrew WRONKA, Port Monmouth, NJ (US)

(73) Assignee: SIEMENS AKTIENGESELLSCHAFT

(21) Appl. No.: 12/947,364

(22) Filed: Nov. 16, 2010

(30) Foreign Application Priority Data
Nov. 18, 2009 (DE) 10 2009 053 819.4

(51) Int. Cl. G09G 5/00

(52) U.S. Cl. 345/634

(57) ABSTRACT

A particularly simple and flexibly operable method for displaying digital medical images or series of images is specified. In accordance with at least one embodiment of the method, a display surface is generated on a screen, within which a plurality of images or series of images can be displayed. A number of surface segments are formed on the display surface, in which a group of images or series of images is shown in each instance. The number of surface segments can herewith be arbitrarily prespecified and changed by a user. A system for implementing the method includes, in at least one embodiment, a viewport manager for generating the display surface and forming any number of surface segments.

### PRIORITY STATEMENT

The present application hereby claims priority under 35 U.S.C. §119 on German patent application number DE 10 2009 053 819.4 filed Nov. 18, 2009, the entire contents of which are hereby incorporated herein by reference.

### FIELD

At least one embodiment of the invention generally relates to a method for displaying digital medical images. At least one embodiment of the invention also generally relates to a system set up to implement at least one embodiment of the method.

### BACKGROUND

Image-assisted medical diagnosis methods, like for instance computed tomography or magnetic resonance tomography, are nowadays increasingly performed on computers. In particular, the recorded images are generated and processed here in the form of digital image data records. The diagnostics, i.e. the examination of images according to medically relevant findings, also takes place increasingly on a screen.

Specialized software systems are herewith frequently used in practice to display images. Such a system generally meets requirements stipulating that a current image or a current series of images must regularly be compared in medical practice with a corresponding image and/or a corresponding series of images of an earlier examination, e.g. in order to track the development of a disease or a healing process.

Display systems for medical images (so-called viewers) therefore often comprise a defined surface region of a screen surface for current image data and another surface region for earlier image data. For instance, images of the current series of images are always shown on the right side of the screen and images of an earlier series of images are always shown on the left side of the screen.

### SUMMARY

In at least one embodiment of the invention, a method is specified for displaying digital medical images and a corresponding system, which enables a better, in particular more flexible operation.

With respect to at least one embodiment of the method, provision is made to generate a display surface on a screen, within which a plurality of images can be displayed. A number of delimited surface segments (so-called viewports) is formed on this display surface, with a group of images or series of images being shown in each surface segment respectively. In accordance with the invention, the number of these surface segments can herewith be arbitrarily prespecified and changed by a user.

The surface segments are preferably arranged adjacent to one another on the screen, without overlap. Alternatively, provision can also be made for all or some surface segments, particularly if the number of surface segments exceeds a specific threshold, to be shown completely or partially overlapping on the display surface. The uppermost surface segment is in this case expediently visible in the overlap region, with it being possible to leaf through the overlapping surface segments in the manner of tabs for instance.

In an example embodiment of the method, the size of the individual surface segments and/or their arrangement on the display surface can also be arbitrarily prespecified and changed by the user. In addition or alternatively, provision is to this end optionally made for the number and/or size of the images and/or series of images which are shown and/or can be shown per surface segment also to be arbitrarily prespecifiable and changeable by the user.

The afore-described change options provide the user of the method with the freedom to decide how many images/series of images and the manner in which the images/series of images are to be displayed at the same time on the screen and enable the display to be particularly flexibly adjusted to his/her requirements. In particular, the user can simultaneously display images/series of images of any number of medical examinations on the screen.

To provide the user with a good possibility of comparison between two specific images, in the case of a plurality of displayed images/series of images, provision is made in an advantageous variant of the method for each of the displayed images/series of images to be copied or moved from the surface segment originally assigned thereto into another surface segment. The images/series of images to be compared can therefore be positioned directly adjacent to one another irrespective of their original position. A so-called drag-and-drop process is preferably used in accordance with the method to copy or move images/series of images, with which the image or series of images to be copied or moved is clicked with the mouse or another pointing device, moved into the desired target segment and disposed there by a corresponding user command, in particular by releasing the mouse button. Provision is optionally made for the drag-and-drop process to also be replaceable by a key-controlled copying or moving of the selected image and/or the embodied series of image by way of the Windows clipboard or a comparable buffer.

To provide the user with the overview of the displayed images/series of images, provision is made in a further development of this method variant for each image and/or series of images, which was copied or moved from its original surface segment into another surface segment, to be identified in the display in the other surface segment by a visual marker as a foreign image and/or foreign series of images. This marking is in particular performed in that a specific symbol (also referred to as “icon”) is superimposed onto the moved or copied image and/or series of images. Other types of markers are however likewise conceivable. The copied or moved image and/or series of images could be provided for instance with a frame which differs from the unmoved images/series of images.

In an example embodiment of the method, provision is made for images/series of images, which originate from one and the same examination, only ever to be displayed in an original state in each of the surface segments. Each surface segment is therefore assigned to a specific examination in the original state. Compared with this original state, the display surface can then be changed in a preferred embodiment of the method by means of user interaction, by the user moving or copying individual images/series of images into other surface segments. A number of examinations can also be called up.

Within the scope of at least one embodiment of the method, a so-called identity display function is in turn made available in order to provide the user with an overview of the displayed images/series of images. Within the scope of this identity display function and in response to a corresponding user command, those displayed images/series of images which originate from a specific examination specified by the user are identified as belonging together, irrespective of their current display site. This identification is preferably performed in that the affected images/series of images are provided with an obvious, e.g. color-highlighted frame. Other types of markers are however also conceivable here. For instance, the coloring of the relevant images/series of images could be changed temporarily in response to a user command. In particular, these images/series of images could be shown temporarily as translucent grey or flashing etc.

In respect of at least one embodiment of the system, the system, generally speaking, is subsequently set up to implement at least one embodiment of the afore-described method. In detail, the system includes a viewport manager, which is set up to generate a display surface on a screen, within which a plurality of images/series of images can be displayed, and to form a number of surface segments (viewports) on this display surface in order to display a group of images or series of images in each instance. The number of surface segments to be formed can herewith be arbitrarily prespecified to the viewport manager by a user. In particular, the number of surface segments to be formed, which is prespecified to the viewport manager, can also be changed arbitrarily by the user.

A software program is herewith referred to as a system in the narrower sense, the software program automatically implementing at least one embodiment of the afore-described method, if it runs on a computer. The viewport manager is in particular a software module of this computer program. In the further sense, a computer is also referred to as a system, on which computer the computer program is installed in an executable form.

In an advantageous embodiment of the system, the viewport manager is set up such that the size of the surface segments and/or their arrangement on the display surface can be arbitrarily prespecified or changed by the user. To this end, in addition or alternatively, the viewport manager is preferably set up such that the number and/or size of the images/series of images which are displayed or can be displayed per surface segment can be arbitrarily prespecified or changed by the user.

In a further advantageous variant of the system, the viewport manager is set up such that each displayed image/series of images can be copied or moved into another surface segment in response to a corresponding user command, in particular by way of a drag-and-drop process. The viewport manager is optionally also set up here to identify each copied or moved image and/or each copied or moved series of images in the display in the other surface segment by way of a visual marker as a foreign image.

In at least one embodiment of the system, the viewport manager is set up only ever to display images/series of images which originate from one and the same examination in an original state in each of the surface segments. The viewport manager therefore herewith assigns a specific examination to each surface segment, with it being possible for this original state, in a preferred embodiment of the system, to subsequently be changeable by the user by copying and moving the images/series of images.

In a further embodiment, the system also includes an identity display module. In response to a certain user command, this identity display module is herewith set up to identify those displayed images/series of images which originate from a specific examination specified by the user as belonging together irrespective of their current display location. The identity display module is in turn preferably a software module. The identity display module can herewith be implemented as part of the viewport manager or separately herefrom.

### BRIEF DESCRIPTION OF THE DRAWINGS

Example embodiments of the invention are subsequently described in more detail with reference to a drawing, in which;

FIG. 1 shows a system for displaying digital medical images, having a software-specific viewport manager implemented within the scope of a computer program and installed on a computer,

FIGS. 2 to 5 each show a display surface generated by the viewport manager, on which display surface several surface segments (viewports) are formed to display a group of images in each instance.

Parts and variables which correspond to one another are always provided with the same reference characters in all the figures.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

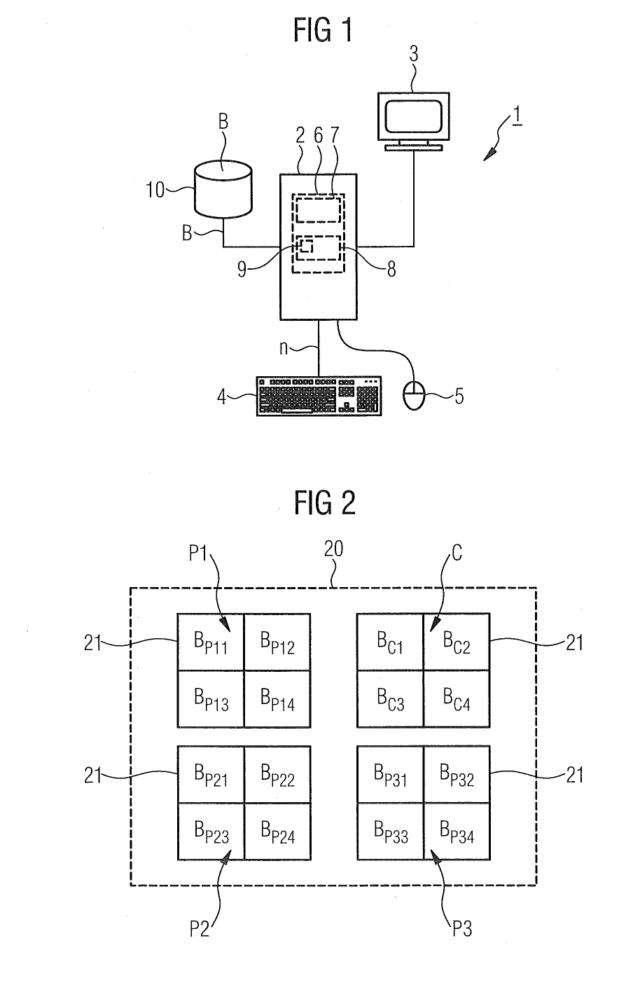

The system shown schematically in FIG. 1 includes a computer 2 with connected peripheral devices, namely in particular a screen 3, a keyboard 4 and a mouse 5. In addition or alternatively to the peripheral devices shown, further peripheral devices, in particular a printer, a touchpad, track ball etc. can be connected to the computer 2.

The system 1 also includes a computer program 6 which is installed so as to be executable on the computer 2. This computer program 6 includes in particular a software module subsequently referred to as a viewport manager 7, and a further software module, which is subsequently referred to as an examination manager 8. The system 1 also includes an identity display module 9, which, in the exemplary embodiment according to FIG. 1, is implemented using software as part of the examination manager 8.

The system 1 is used to display digital medical images, particularly within the scope of medical diagnostics. System 1 is therefore a medical diagnostic center for instance. The computer 2 is in particular a conventional PC, and the computer program 6 is in particular a so-called PACS viewer. The individual software modules of this computer program 6, namely in particular the viewport manager 7 and the examination manager 8 as well as the identity display module 9, can herewith optionally exist as software components which are separated from one another or form functional components of a uniform program.

The images to be displayed (generally referred to with B), which are computed tomograph (CT) sectional images for instance, can be stored at least partially locally on the computer 2. The computer 2 is however preferably networked from a communications perspective with a central image memory 10 within the scope of a so-called PACS (Picture Archiving and Communication System) and relates to the images B to be displayed.

During operation, the viewport manager 7 generates a display surface 20, (shown in further detail by way of example in FIG. 2), on the screen 3, within which the images B are displayed. The display surface 20 is generated for instance within a so-called window of a graphical user interface, e.g. within the scope of an MS Windows operating system. The display surface 20 may alternatively also be generated as a complete image, which extends across the entire screen surface.

Within the display surface 20, the viewport manager 7 generates a number n of (also referred to as viewports) delimited surface segments 21, in which a group of images B is conventionally shown. In the example according to FIG. 2, the viewport manager 7 generates four surface segments 21, in which four images B can be displayed in each instance. In a basic state, the viewport manager 7 herewith initially assigns each surface segment 21 to a specific examination, and therefore represents image B of this examination only in the assigned surface segment 21. Images B_{C1} to B_{C4} of a current examination are thus firstly shown in the surface segment 21 shown in the top right of FIG. 2, while in the top left surface segment 21, images B_{P11} to B_{P14} of the preceding examination P1 are shown, in the bottom left lower surface segment 21 images B_{P21} to B_{P24} of the penultimate examination P2 and in the right lower surface segment 21, if available, images B_{P31} to B_{P14} of the antepenultimate examination P3 are shown.

A system user can herewith arbitrarily prespecify and change the number n of surface segments 21 to be formed, e.g. by way of the keyboard 4. The specification of the number n can herewith also take place incrementally, by the system user specifying the number n not as a digit but instead by being able to generate new surface segments 21 one after the other by predetermined key combinations or mouse clicks or by being able to delete existing surface segments 21.

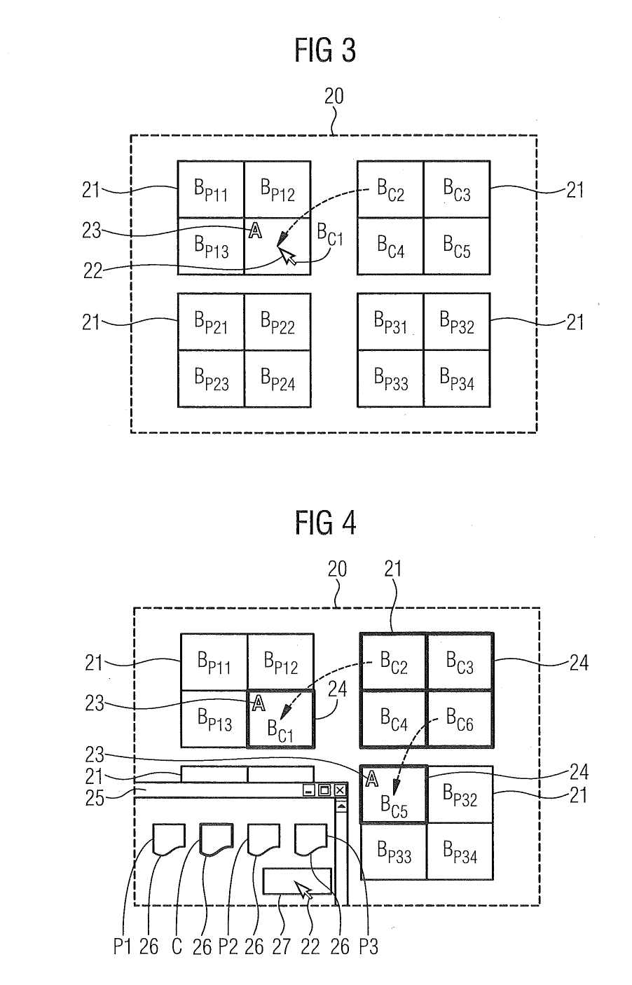

To provide the system user with an easier comparison of two images B, the viewport manager 7 includes a drag-and-drop function, within the scope of which the system user “clicks on” each of the illustrated images B with the mouse cursor 22 and is able to move the image out of the originally assigned surface segment 21 into another surface segment 21. This is shown by way of example in FIG. 3 on the image B_{C1}, which is moved from its original position in the right upper surface segment 21 to the position in the left upper surface segment 21 which was previously assigned to the image B_{P14} in accordance with FIG. 2. The described drag-and-drop action may alternatively be replaced by the button-controlled displacement of the image B_{C1} across the clipboard. The image B_{C2} moved into the left upper surface segment 21 replaces the original image B_{P14} there. The viewport manager 7 closes the gap generated by the displacement process in the right upper surface segment 21, by receiving a new image B_{C5} of the current examination in this surface segment 21 and rearranging the images B_{C2} to B_{C5} in accordance with their sequence.

To remind the system user about performed image displacements and thus to improve the overview of the displays, the viewport manager 7 marks all the images B moved from the originally assigned surface segment 21 with a specific symbol 23 (or icon) which is superimposed onto the moved image B. By way of example, a capital letter “A” is superimposed by way of the image B_{C1} moved in accordance with FIG. 3, in order to identify this image B_{C1} as a “foreign image”, i.e. externally positioned image. Each image B can be moved any number of times. Furthermore, the movements can be reversed again individually or in their entirety.

The identity display module 9 is used to further improve the overview. In response to a specific user command, this identity display module 9 effects a marking of all displayed images B, which belong to a specific examination which is specified by the system user, namely independently of the surface segment 21 in which these images B are located and/or of the surface segment into which these images were moved. The marking takes place for instance by the affected images being provided with a strikingly colored, e.g. red edge 24. This is indicated by way of example in FIG. 4 for the images B_{C1} to B_{C6} of the current examination, of which the image B_{C1} was moved into the left upper surface segment 21, and the image B_{C5} was moved into the right lower surface segment 21.

The identity display module 9 is implemented by way of example as part of the examination manager 8. This is used to superimpose a so-called patient jacket 25 on the screen 3. The patient jacket 25 is a window, in which, in addition to other data, the imaging examinations performed on a specific patient are listed using symbols in the form of icons for instance. By way of example, FIG. 4 shows corresponding icons 26 for the current examination C and the earlier examinations P1 to P3. The patient jacket 25 also includes a command input field 27 (button), by way of which the identity display function implemented by the identity display module 9 can be called up. To call up this identity display function, the system user initially clicks the icon 26 of the desired examination in the patient jacket 25 (here the icon 26 assigned to the current examination C), which is subsequently identified by color as active. The system user then clicks the command input field 27 using the mouse cursor 22, in order to start the identify display function.

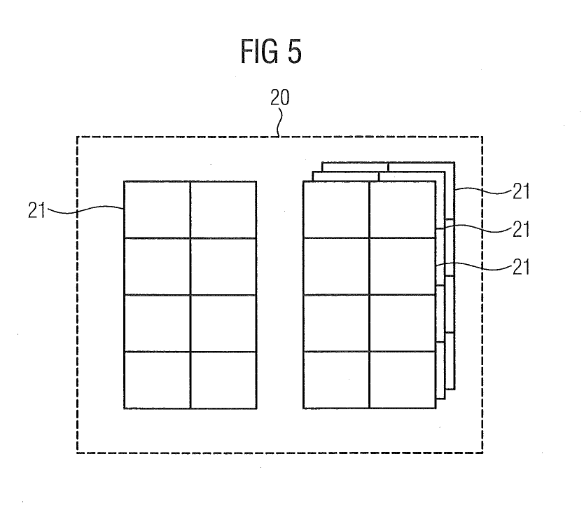

In the afore-described examples, the surface segments 21 are always arranged adjacent to one another on the display surface 21 without overlap. In an alternative embodiment of the system 1, the viewport manager 7 is by contrast embodied to display at least part of the surface segments 21, e.g. in the manner of tabs, partially overlapping on the display surface 20, so that only the uppermost surface segment 21 can be seen completely. The system user is herewith able to “leaf through” the thus stacked surface segments 21 using mouse clicks, alternatively by way of a specific key combination. A corresponding arrangement of four surface segments 21 is shown by way of example in FIG. 5.

The viewport manager 7 is preferably embodied such that it only then arranges the surface segments 21 in stacks if its number n exceeds a predetermined minimum number. In the example according to FIG. 5, the viewport manager 7 accordingly arranges the first two surface segments 21 adjacent to one another on the display surface 20, while it stacks each further generated surface segment 21 on the already existing surface segments 21.

With the system variant according to FIG. 5, the viewport manager 7 is also set up so that the system user is able to freely select and change the number of images B which can be displayed per surface segment 21. According to FIG. 5, the view port manager 7 is configured by the system user for instance such that eight images B can be shown per surface segment 21.

Provision can optionally be made for the number of images which can be displayed per surface segment 21 to be individually adjustable for each surface segment 21. In addition or alternatively, provision can be made for the size of each displayed image to be individually changeable by the system user. In addition or alternatively, provision can in turn also be made for the images B assigned to each surface segment 21 to be displayed in an irregular sequence.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, non-transitory computer readable medium and non-transitory computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a non-transitory computer readable medium and is adapted to perform any one of the aforementioned methods when run on a computer device (a device including a processor). Thus, the non-transitory storage medium or non-transitory computer readable medium, is adapted to store information and is adapted to interact with a data processing facility or computer device to execute the program of any of the above mentioned embodiments and/or to perform the method of any of the above mentioned embodiments.

The non-transitory computer readable medium or non-transitory storage medium may be a built-in medium installed inside a computer device main body or a removable non-transitory medium arranged so that it can be separated from the computer device main body. Examples of the built-in non-transitory medium include, but are not limited to, rewriteable non-volatile memories, such as ROMs and flash memories, and hard disks. Examples of the removable non-transitory medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE CHARACTERS

1 System
2 Computer
3 Screen
4 Keyboard
5 Mouse
6 Computer program
7 Viewport manager
8 Examination Manager
9 Identity display module
10 Image memory
20 Display surface
21 Surface segment
22 Mouse cursor
23 Symbol
24 Edge
25 Patient jacket
26 Icon
27 Command input field
B_{C1}-B_{C6} Image
B_{P11}-B_{P24} Image
B_{P31}-B_{P34} Image
B_{P41}-B_{P44} Image
C (current) examination
n number
P1 (earlier) examination
P2 (earlier) examination
P3 (earlier) examination

What is claimed is:

1. A method for displaying digital medical images or a series of images, comprising:
generating a display surface on a screen, within which a plurality of images of the series of images are displayable; and
forming a number of surface segments on the display surface, a group of the images or series of images being displayed in each surface segment, the number of surface segments being arbitrarily prespecifiable and changeable by a user.

2. The method as claimed in claim 1, wherein at least one of a size of the surface segments and an arrangement of the surface segments on the display surface is arbitrarily prespecifiable and changeable by the user.

3. The method as claimed in claim 1, wherein at least one of the number and size of the series of images displayed per surface segment being arbitrarily prespecifiable and changeable by the user.

4. The method as claimed in claim 1, wherein each image or series of images displayed is copied or moved from the surface segment originally assigned thereto into another surface segment.

5. The method as claimed in claim 4, wherein each copied or moved image or image series in the display is identified as a foreign image in the other surface segment by a visual marker.

6. The method as claimed in claim 1, wherein only images or series of images are displayed in an original state in each of the surface segments respectively, said images or series of images originating from the same examination.

7. The method as claimed in claim 1, wherein those displayed images or series of images, which originate from a specific examination specified by the user, are identified as belonging together in response to a user command irrespective of their current display site.

8. System for displaying digital medical images or a series of images, comprising:
a viewport manager, configured
to generate a display surface on a screen, within which a plurality of the images or series of images are displayable, and
to form a number of surface segments on the display surface in order to display a group of images or series of images in each instance, with the number of the surface segments to be formed being arbitrarily prespecifiable to the viewport manager by a user.

9. The system as claimed in claim 8, wherein at least one of the size of the surface segments and the arrangement of the surface segments on the display surface is arbitrarily prespecifiable to the viewport manager by the user.

10. The system as claimed in claim 8, wherein at least one of the number and size of the images or series of images displayed or displayable per surface segment being arbitrarily prespecifiable to the viewport manager by the user.

11. The system as claimed in claim 8, wherein the viewport manager is set up to copy or move each displayed image or each displayed series of images, in response to a corresponding user command from the surface segment originally assigned thereto into another surface segment.

12. The system as claimed in claim 11, wherein the viewport manager is set up to identify at least one of each copied or moved image and each copied or moved series of images in the display in the other surface segment as a foreign image by way of a visual marker.

13. The system as claimed in claim 8, wherein the viewport manager are set up only ever to display images or series of images, originating from the same examination, in an original state in each of the surface segments.

14. The system as claimed in claim 8, further comprising:
an identity display module which, in response to a corresponding user command, is set up to identify those displayed images or series of images, which originate from a certain examination specified by the user, as belonging together irrespective of their current display location.

15. The method as claimed in claim 2, wherein at least one of the number and size of the series of images displayed per surface segment being arbitrarily prespecifiable and changeable by the user.

16. The method as claimed in claim 2, wherein each image or series of images displayed is copied or moved from the surface segment originally assigned thereto into another surface segment.

17. A non-transitory computer readable medium including program segments for, when executed on a computer device, causing the computer device to implement the method of claim 1.

18. The system as claimed in claim 9, wherein at least one of the number and size of the images or series of images displayed or displayable per surface segment being arbitrarily prespecifiable to the viewport manager by the user.

19. The system as claimed in claim 9, wherein the viewport manager is set up to copy or move each displayed image or each displayed series of images, in response to a corresponding user command from the surface segment originally assigned thereto into another surface segment.
